(19) United States
(12) Patent Application Publication
(10) Pub. No.: US 2018/0225777 A1
(43) Pub. Date: Aug. 9, 2018

(54) SECURING A SOCIAL ENGAGEMENT VIA A SHARED TRANSACTION

(71) Applicant: Other Half, LLC, Salt Lake City, UT (US)

(72) Inventor: Brigham Jackson, Salt Lake City, UT (US)

(21) Appl. No.: 15/932,436

(22) Filed: Dec. 21, 2016

(51) Int. Cl. G06Q 50/00; G06Q 20/32; G06Q 30/02

(52) U.S. Cl. CPC G06Q 50/01; G06K 19/06028; G06Q 30/0239; G06Q 20/3224

(57) ABSTRACT

Implementations of the present invention comprise systems, methods, and apparatus configured to enable users to select each other and meet up in a secure, open manner. In one implementation, for example, users use a mobile application to identify each other using online profiles, and then select each other for introduction. The application then provides the mutually selected users with half of a coupon for use at a public location, such as a local restaurant. The application on each user's phone then enables the coupon for use at the public location only when the mutually selected users are in the location, and near each other. Once the coupon is enabled, the users can present the coupon at the location, obtain a discount, and participate in the agreed activities.

### BACKGROUND OF THE INVENTION

### 1. Technical Field

Implementations of the present invention relate to social media, and in particular social introduction applications, including those used for dating.

### 2. Background and Relevant Art

As the Internet and the accompanying Internet commerce have expanded, user and application creators employ internet functionality increasingly to social introduction applications. Of recent popularity are applications related to enabling users who have never met before, but who share common interests, an avenue to meet up. Dating applications are such an example.

Unfortunately, common dating or other form of social introduction applications suffer from a number of difficulties that ultimately limit the numbers and/or types of users that would use such applications. In particular, current social meeting applications (e.g., “dating apps”) enable users to select each other based entirely on online profiles and pictures that are easily spoofed. Moreover, when the users agree to meet up after some initial communications with each other, the users must select the locations and times for meeting essentially at random. The ease of spoofing profiles, pictures, and interests can make it difficult for users keeping these issues in mind to agree to meet. Moreover, if the users are not careful about the time and location of meeting up, there is great potential for physical and other types of harm or abuse, especially if the users meet for the first time in a private, unsecured location, or in a location controlled by one but not both of the users. Not surprisingly, people often view dating apps primarily as a sexual link-up tool rather than as an application that be useful for initiating and developing long term, meaningful relationships.

In addition, social dating in general tends to require money and other resources that some users (particular younger users, such as college-aged users) may find less accessible. Thus, although dating apps tend to be capable at introducing people and helping people select a match based on a wide variety of personal criteria, the negative associations of such applications coupled with the real costs of dating can turn off a number of users. Some of these users might otherwise be interested in meeting new people, or might even be less socially inclined, but might find value in online tools that make social introductions easier and more secure.

Accordingly, there are a number of problems in the art of social introduction applications that can be addressed.

### BRIEF SUMMARY OF THE INVENTION

Implementations of the present invention comprise systems, methods, and apparatus configured to enable users to select each other and meet up in a secure, open manner. In one implementation, for example, users use a mobile application to identify each other using online profiles, and then select each other for introduction. The application then provides the mutually selected users with half of a coupon for use at a public location, such as a local restaurant. The application on each user's phone then enables the coupon for use at the public location only when the mutually selected users are in the location, and near each other. Once the coupon is enabled, the users can present the coupon at the location, obtain a discount, and participate in the agreed activities at the location.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic of a mobile phone showing an initial user profile for use in connection with an implementation of the present invention;

FIG. 2 illustrates a schematic of a chat dialog box that may be implemented through the application upon mutual selection of users in connection with an implementation of the present invention;

FIG. 3A illustrates a schematic in which the mobile application provides a series of options where the users can agree to meet in connection with an implementation of the present invention;

FIG. 3B illustrates an alternate schematic of the options screen of FIG. 3A, albeit in which the screen provides each user with an option for the same vendor;

FIG. 4 illustrates a schematic of a coupon provided through the mobile application, but before the application enables the coupon in connection with an implementation of the present invention; and

FIG. 5 illustrates a flow diagram in which two users use an activated coupon at a public location in connection with an implementation of the present invention.

### DETAILED DESCRIPTION OF THE PREFERRED EMBODIMENTS

The present invention extends to systems, methods, and apparatus configured to enable users to select each other and meet up in a secure, open manner. In one implementation, for example, users use a mobile application to identify each other using online profiles, and then select each other for introduction. The application then provides the mutually selected users with half of a coupon for use at a public location, such as a local restaurant. The application on each user's phone then enables the coupon for use at the public location only when the mutually selected users are in the location, and near each other. Once the coupon is enabled, the users can present the coupon at the location, obtain a discount, and participate in the agreed activities at the location.

Accordingly, one will appreciate in view of the present specification and claims that implementations of the invention enable users meet each other in a secure way, and thus incentivize a much wider number of users to use the application. Moreover, as understood more fully herein, implementations of the present invention further provide benefits to local businesses, who can see increased traffic from users who might not initially be inclined to participate in offerings due to cost issues.

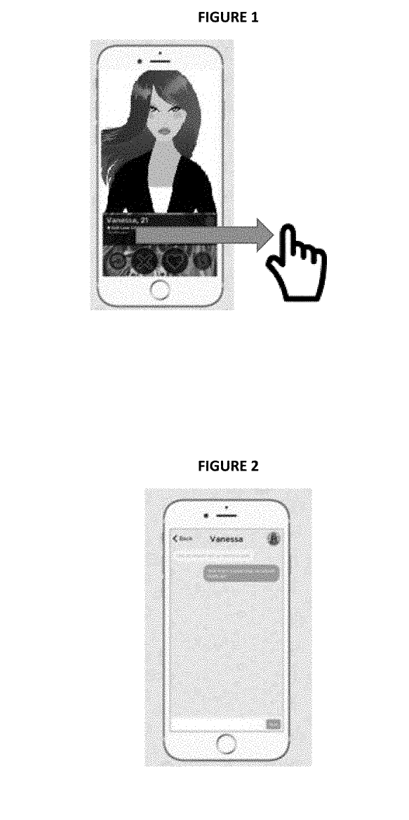

Referring now to the Figures, FIG. 1 illustrates a schematic of a mobile phone showing an initial user profile. In at least one implementation, the mobile application enables users to create a profile that includes any number of pictures and other categories and descriptors. The users can then swipe right or left on items, such as by selecting on pictures of user that they find attractive, whether from the photo(s) or other descriptors included in the profile. In one implementation, swiping right indicates that the user likes what is presented in the application, whereas swiping left equals disliking and avoiding that particular profile. Of course, one will appreciate that the mobile app can be configured to select the users presented in any number of ways, such as by swiping up, left, right, down, or even by holding a finger on the screen for a determined time interval.

In at least one application, the mobile application does not introduce users to the next phase of the relationship unless the person corresponding to the selected profile provides an affirmative response (e.g., a return “like”), or otherwise agrees through the application to meet the initially selecting user. When there is a mutual like/selection from both users (i.e., the selecting user and the selected user), the mobile application assigns both of the users a discount/coupon, and can further enable other features. For example, FIG. 2 illustrates a schematic of a chat dialog box, which the application provides after selection so that the users can further communicate. In addition, the mobile application can present users with a number of options for using a coupon code, selecting places to use the coupon, and so on.

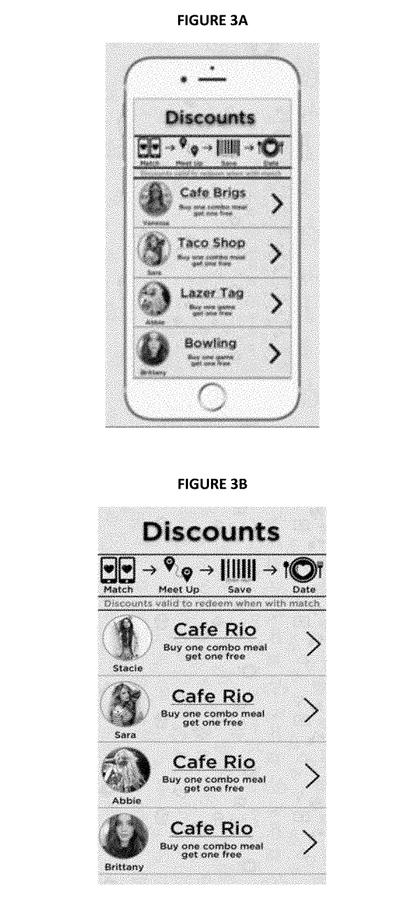

For example, FIG. 3A illustrates a schematic in which the mobile application provides a series of local, public options at which the users can agree to meet. That is, the public options include public venues, such as restaurants, that have opted in to the system. In the illustrated case, FIG. 3A indicates places where the users can agree to meet and use their coupon code, or more broadly a “transaction element.” Upon mutual agreement of a particular meeting location, the mobile application can then present one or both of the users with a set of options that can be used with the transaction element at the agreed location.

One will appreciate in view of the specification and claims that providing a mutually agreeable public location can provide a number of benefits. Firstly, this enables a relatively safe physical space for the users to meet. It is safe at least on part in one implementation because the local, public location is one where unrelated third parties are likely to be present (e.g., other guests of the restaurant), and is also a location monitored, cleaned, and generally maintained by operators that are less likely to have a relationship to the users. This means that the operators of the local, public location are also more likely to be believed by the users to be independently accountable to local authorities and to general public opinions than they will be to any particular user of the application.

FIG. 3B illustrates a similar schematic to FIG. 3A, except one in which the application provides a single vendor for the users to select. For example, a vendor might coordinate with the application host to be the vendor of the month, so that that vendor is the only vendor that the app provides in that area to users. In either case, the users would still both need to select the option in order to agree to complete the meeting and activate the transaction element. Specifically, once the users exchange mutual selections, the mobile application assigns the transaction element or coupon, or more specifically “half” a transaction element/coupon to each user. In at least one implementation, the mobile application provides a time out feature so that the transaction element is only valid for a set period of time, but the users have only half of the discount. The application, in turn, only enables the transaction element/coupon once the mutually selected users are deemed to be close together and in the agreed location.

That is, the application identifies the location of each user, such as through GPS, WIFI, BLUETOOTH, or other appropriate location mechanisms implemented through the respective user's phone in order to determine that both users are in the agreed location, and within a particular distance of each other. In one implementation, for example, the application does not enable the transaction element/coupon if the users meet at another location other than the agreed location. In another implementation, the application does not enable the transaction element/coupon until the users are within 1-3 feet of each other in order to enable better determinations of the agreed users in more public, crowded spaces. In still another implementation, the application provides an alert to one or both of the user's phones when the agreed users are close enough together.

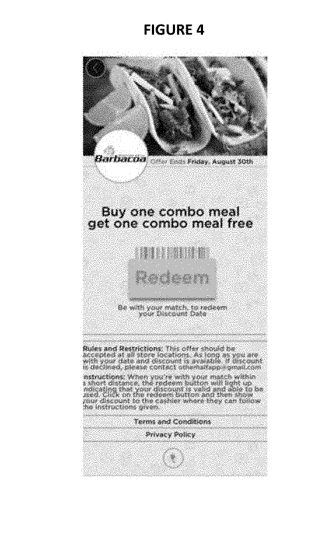

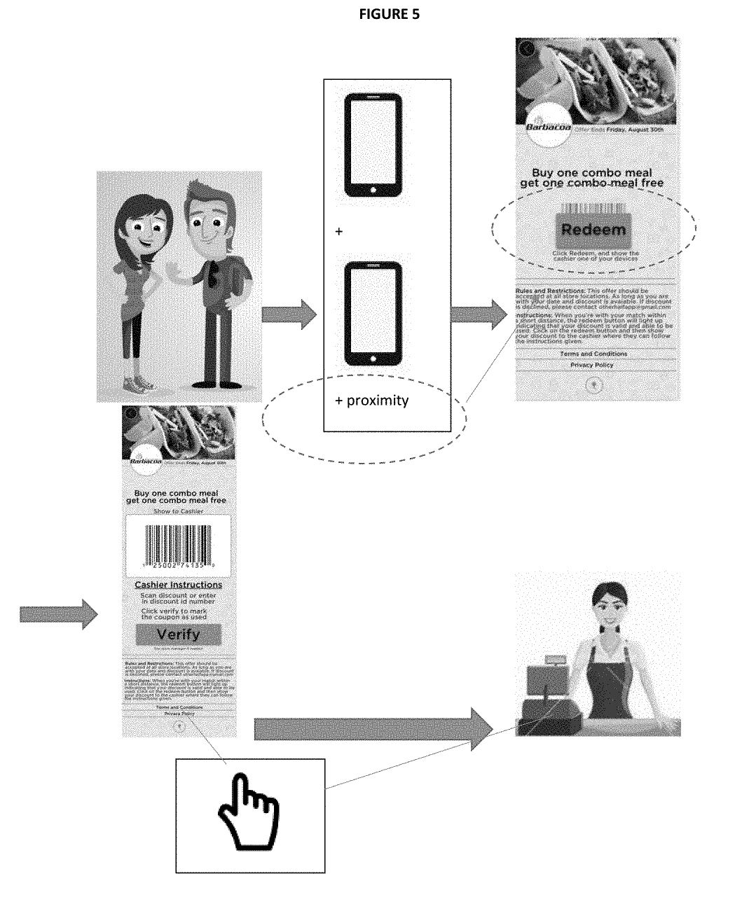

FIG. 4 illustrates a schematic of a transaction element/coupon provided through the mobile application, but before the application enables the transaction element/coupon in connection with an implementation of the present invention. As shown, the “Redeem” portion is not selectable because one or more criteria required for activation have not been met, as described above. Once the criteria have been met, however, the Redeem button changes appearance (e.g., becomes bolded, changes color, becomes selectable, etc.), and the users can select the button to redeem the transaction element/coupon. In one implementation, this includes the respective mobile applications for each corresponding user sending a signal to an application server hosting the applications (e.g., a remote application server) that all criteria have been met for activation of the transaction element/coupon.

The application server then sends a response signal to each user's respective phone (or alternatively just one of the phones) with sufficient data enabling the transaction element/coupon to activate. One or both of the users can then select the “Redeem” button, which then reveals one or more codes (e.g., a barcode or QR code) to be verified by the operator of the public location. For example, the mobile application might dissolve or remove the Redeem button to reveal a transaction element/coupon code behind the button, or perform some other visible function that reveals the transaction element.

Along these lines, FIG. 5 illustrates a flow diagram in which two users use an activated transaction element/coupon at the public location. In an initial step, FIG. 5 illustrates two users that have agreed to meet, such as both by swiping right (e.g., FIG. 1) at an earlier point in time. As previously described, the mobile app then assigns a transaction element/coupon. For example, Jack and Jill (e.g., a first user and a second user) like each other in the app, thus equally match each other on the app. The mobile app can then assign both Jack and Jill a discount of the month, and provide half of a corresponding transaction element to Jack's and Jill's respective mobile applications.

For example, the mobile app might enable a “buy one get one free combo meal at [x location]” (e.g., FIGS. 3A-3B), and Jack's and Jill's apps each show this option on their phone. As described, the mobile application provides each user half of the discount. so that the transaction element/coupon can only be activated once certain criteria about each user's location are satisfied. Specifically, each selected user requires the other half of the discount to be present to activate the transaction element/coupon.

FIG. 5 further shows in a next step wherein both of the users' phones are sufficiently close together (e.g., within “proximity”) and thus the mobile application enables a “Redeem” feature. That is, each user brings their respective phones (or other relevant device, e.g., a tablet device, or other PC) within a distance that the device and application recognize that they're with each other. For example, each user's device directly recognizes the proximity of the other user's device through a unique device ID, or recognizes proximity through GPS, WIFI location, or Bluetooth location mechanisms. Upon detection of user proximity within the selected location, the application enables the respective heir halves of the transaction element/coupon together to create a full transaction element/coupon. The users can now present the barcode, transaction element/coupon code, QR code, or other appropriate value to the operator of the public location.

As shown in FIG. 5, in at least one implementation, the users present the barcode to a cashier who then reads the relevant transaction element/coupon code. In at least one implementation, the cashier can then validate the transaction element/coupon code. For example, the cashier can physically select the “Verify” button that shows up on one or both of the user's phones. Upon selection, the respective app sends a signal to the application server that indicates that the transaction element/coupon has been used, and disabling that particular transaction element/coupon for future use. Alternatively, the cashier implements a point of sale device that digitally reads the code presented by the users, and communicates with the application server to confirm the validity of the transaction element/coupon code to the cashier, as well as to indicate at the application server that the transaction element/coupon code has now been used. In at least one implementation, a single use by the users at the location disables the transaction element/coupon from future use. In other cases, however, the location operator may implement the transaction element/coupon so that it has a specific number of uses so long as both of the users are present at the same time.

Accordingly, one of ordinary skill in the art having read the present specification and claims will appreciate that implementations of the present invention solve a number of problems with prior social applications. These solutions are found at least in part through computerized systems, and applications as described herein, such as a system employing an application server, local installations (or instances of a remote location) of a mobile application, and a third party location operator that agrees to a form part of a transaction. At least some of the advantages include increased incentives for a number of people that might ordinarily be less inclined to use social meeting applications to use such applications, enabling positive, safe social activities, and to further provide opportunities for businesses and other third parties to incentivize traffic and build positive reputations as social meeting areas.

Although the subject matter has been described in language specific to structural features, modules, and/or methodological acts, it is to be understood that the subject matter defined in the appended claims is not necessarily limited to the described features, modules, or acts described above, or the order of the acts described above. Rather, the described features, modules, and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A computer system for enabling social interactions through a dating or other type of social interaction application:
one or more processors;
one or more storage devices having stored thereon computer-executable instructions that are executable by the one or more processors, and that configure the system to manage deployment of a shared transaction element between two or more parties, including implementing the following:
send one or more user profiles to a mobile application upon request from the mobile application;
receive one or more selections of the sent one or more user profiles;
provide an indication to the selected one or more user profiles that a first user has selected a profile of a second user, the second user being one of the selected one or more user profiles;
provide an indication to the first user that the second user has mutually selected the first user;
assign half of a transaction element to the first user and half of the transaction element to the second user, wherein the transaction element corresponds to an activity to be undertaken at a physical location, and wherein the transaction element is inactive until one or more criteria including a location criterion is met;
receive an indication that confirms satisfaction of the one or more criteria including at least the location criterion for each of the first and second users; and
activate the transaction element for use by the first and second users.

2. The computer system as recited in claim 1, wherein the transaction element comprises a coupon or discount code.

3. The computer system as recited in claim 2, wherein the transaction element is represented in the form of a barcode, QR code, or alphanumeric value that is readable by a third party.

4. A method performed at a computer system for enabling social interactions through a dating or other type of social interaction application, comprising:
receiving one or more selections of one or more user profiles;
providing an indication to the selected one or more profiles that a first user has selected that profile;
providing an indication to the first user that a second user of the selected one or more profiles has mutually selected the first user;
assigning half of a transaction element to the first user and half of the transaction element to the second user, wherein the transaction element corresponds to an activity to be undertaken at a physical location, and wherein the transaction element is inactive until one or more criteria including a location criterion is met;
receiving an indication that confirms satisfaction of the one or more criteria including at least the location criterion for each of the first and second users; and
activating the transaction element for use by the first and second users.

5. The method as recited in claim 4, further comprising:
receiving an indication from an operator corresponding to the transaction element that the first user and second user have presented the transaction element; and
performing one or more of:
verifying the transaction element to the operator; and
disabling the transaction element from future use.

6. The method as recited in claim 4, wherein the location criterion comprises a determination of physical proximity, including presence within a range of a predetermined distance, of the first and second users through one or more of GPS, WIFI, or BLUETOOTH.

7. The method as recited in claim 6, wherein the predetermined distance comprises 3 ft, 5 ft, 20 ft, or 100 ft.
